(19) United States
(12) Patent Application Publication
(10) Pub. No.: US 2013/0208830 A1
(43) Pub. Date: Aug. 15, 2013

(54) SWITCHED-LOAD RESONATING TRANSMITTER FOR PASSBAND POWER LINE COMMUNICATION

(71) Applicant: David W. Rieken, St. Peters, MO (US)

(72) Inventor: David W. Rieken, St. Peters, MO (US)

(73) Assignee: ACLARA POWER-LINE SYSTEMS INC., Hazelwood, MO (US)

(21) Appl. No.: 13/696,486

(22) PCT Filed: May 5, 2011
(86) PCT No.: PCT/US11/35341

§ 371 Date: Jan. 15, 2013

Related U.S. Application Data
(60) Provisional application No. 61/332,406, filed on May 7, 2010.

(51) Int. Cl. H04L 1/00

(52) U.S. Cl. CPC H04L 1/0033
USPC 375/308; 375/295

(57) ABSTRACT

A switched-load, resonant transmitter (T2) for inbound signaling in a two-way automatic communications system (TWACS). The load is purely reactive containing both inductive (L) and capacitive (C) elements. When connected in a power transmission network, the transmitter generates signals useful for passband communications. The transmitter consumes, on average, 100 times less power than resistive switched-load transmitters currently in use in TWACS networks. Signal strength is comparable to that produced by the transmitters currently in use at frequencies near 1 kHz, but is very low otherwise.

### CROSS REFERENCE TO RELATED APPLICATIONS

The present application is related to and claims priority from, U.S. provisional patent application Ser. No. 61/332,406 filed May 7, 2010, which is incorporated herein by reference.

### STATEMENT REGARDING FEDERALLY SPONSORED RESEARCH OR DEVELOPMENT

### BACKGROUND OF THE INVENTION

This invention relates to communications in a two-way automatic communications system (TWACS®) and more particularly to a switched-load transmitter for use in inbound signaling in the communications system.

TWACS transmitters currently in use are resistive load transponders and are incorporated, for example, in an electric meter installed at a customer's home or business location. When used as an inbound message transmitter, the transponder is subject to a number of problems. Among these are heat dissipation, frequency response, and problems with the local voltage supply. The transponders require a great deal of power in order to achieve the signal strengths needed for a communication's link. This is because the switched load in these transponders is largely resistive; and, when the transponder is initially connected to a voltage source, it acts as a voltage divider with much of the voltage drop being across the source. As a result, the supply voltage, as seen by other devices connected to the source, drops dramatically. In a short time, the natural inductance of the voltage source compensates for this and the voltage across the load is largely restored. However, the momentary drop is responsible for observed light flicker, an increased total harmonic distortion, and noise which occurs at radio frequencies. Because the load is resistive, most of the current flowing through it is dissipated as heat.

The strength of a transmitted communication signal (inbound message) increases with the amplitude of the current flowing through the load. Therefore, there is a direct correlation between signal strength and power consumption. Since a transponder can only transmit for so long before the load temperature exceeds acceptable operating limits, this places a constraint on the duty cycle of the transponder, and the data throughput of the communication system. Were it not for this, feeder lines having only a few meters installed on them could have significantly higher throughputs. Studies have shown that, in rural areas, where there typically are only a few meters on a feeder line, throughputs as high as 0.3 bps per meter can be achieved. This correlates to an increase in throughput by a factor of ≈10 in these areas, this being achieved without any significant changes in current TWACS protocols.

At present, TWACS inbound signals are spread over a wide range of frequencies, and this is inefficient for several reasons. First, only a portion of an inbound signal is actually delivered onto the communication channel. This is because distribution transformers significantly attenuate signals at frequencies above a few kilohertz (KHz). Second, noise levels are higher near the 60 Hz frequency where the power signal is concentrated, rather than at other frequencies. This results in low frequencies communications being obscured or masked by noise. The demodulation algorithm used in TWACS for inbound signals focuses on signals between 200-500 Hz. Experimental data indicates that the noise level is sufficiently low in this range that a TWACS inbound signal is not significantly attenuated by the channel over which it is transmitted. Accordingly, any energy expended to generate signals outside this frequency range is not used by the receiver algorithm, and is therefore wasted.

Different proposals have been made to address these problems. One proposal has been to use a digitally controlled voltage source to generate inbound signals because controlling the spectral content of an inbound signal generated by an active transmitter is be readily achieved. Under this approach, bandwidth limited signals are digitally generated and applied to a voltage source through a digital-to-analog (D/A) converter. The proposal has the advantages of: i) providing a minimum efficiency in energy consumed by the transmitter; and, ii) energy going into the unused portion of the spectrum is far less than with current TWACS inbound transmitters. Drawbacks to this approach are that the impedance of the power network, as viewed from the meter, has not been quantified for frequencies above 60 Hz. This makes it difficult to estimate the necessary power requirements. Also, channel transfer functions and noise statistics are not sufficiently understood at this time to ensure that this approach is practical.

A second proposal has been to replace the current resistive load with an inductive load. While this may reduce overall power consumption, the spectral properties of resulting inbound signals appear to differ only slightly from those generated using a purely resistive load transponder. Thus, while this approach has advantages from the standpoint of power consumption, it has the same drawbacks with respect to the signal strength of an inbound signal as current transponders.

### BRIEF SUMMARY OF THE INVENTION

The present disclosure is directed to a resonating transmitter for generating inbound TWACS signals in which the resistive load is replaced with a purely reactive load. The load includes both capacitive and inductive elements. By properly selecting the properties of these elements, the resonating transmitter, with appropriate modulation, will exhibit substantially reduced power consumption while producing inbound signals of sufficient spectral signal strength. The transmitter generates short resonant pulses useful for passband communications while consuming, on average, 100 times less power than resistive switched-load transmitters currently in use in TWACS networks. Signal strength is comparable to that produced by transmitters currently in use at frequencies near 1 kHz, but is very low otherwise.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a Thevenin's equivalent of a current (PRIOR ART) TWACS transmitter having a purely resistive load;

FIG. 2 is a Thevenin's equivalent of a resonant transmitter of the present invention;

FIG. 3 is a circuit for implementing a switch used with the resonant transmitter;

FIG. 4 is a graph of a predicted waveform generated by the resonant transmitter and illustrating both its high-frequency and 60 Hz components;

FIG. 5 is a plot of current flow through and the voltage across a resonant transmitter for a typical transmission;

FIG. 6 is a plot of median power consumption for resonant transmitters using on-off keying (OOK), and

FIG. 7 is a similar plot when phase shift keying (PSK) is used;

FIG. 8 is a block diagram of a digital signal processor (DSP) employed with the resonant transmitter for transmission of signals using PSK or OOK; and

FIG. 9 is a block diagram of a receiver for processing signals transmitted by the resonant transmitter.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to FIG. 1, a prior art transponder T1 for use in TWACS inbound transmissions is represented by its Thevenin equivalent circuit. As shown in FIG. 1, the transponder includes a voltage source V_{S} with a source resistance R_{S}. The transponder also has a purely resistive load as represented by the load resistor R_{L}. Signals are transmitted by toggling a switch S, and when the load is connected to the network, current flows through load resistor R_{L}. This current is detected at a substation (not shown). When switch S is returned to its default position, a drain resistor R_{D} is shorted across the load. Information being transmitted is encoded by operating switch S so that current flows in a controlled manner.

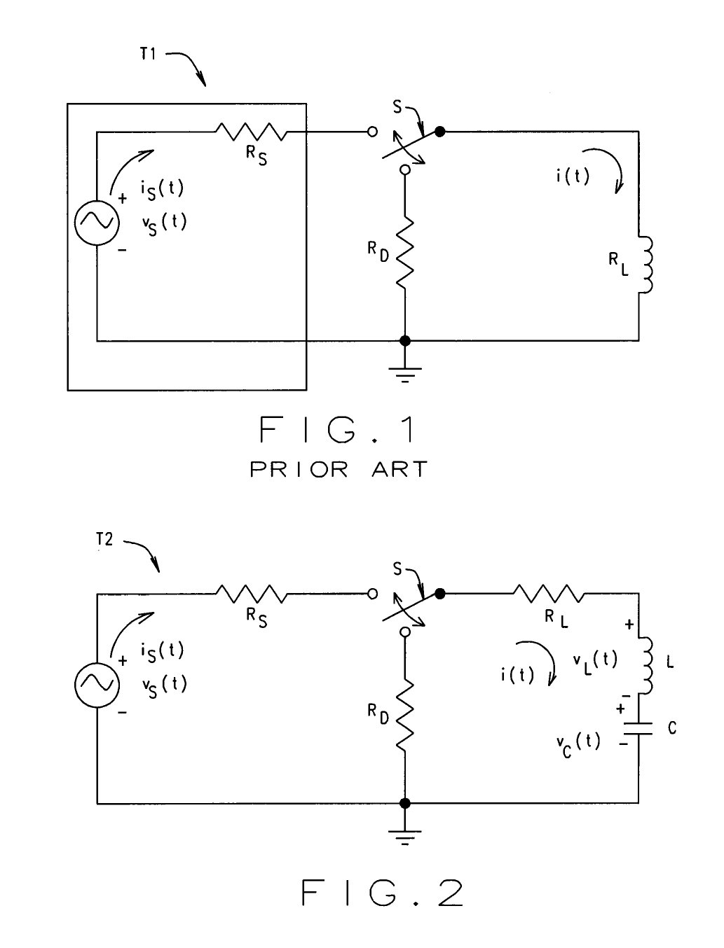

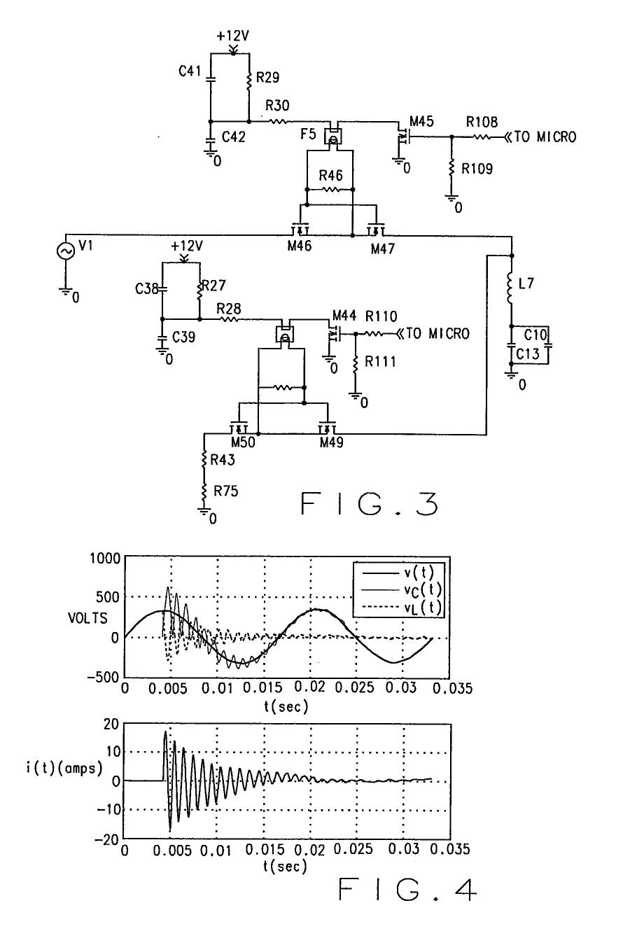

In accordance with the present invention, and as shown in FIG. 2, a switched load transponder T2 largely mitigates those problems previously described when used in place of transponder T1. In accordance with the present invention, and as shown in FIG. 2, transponder T2 is similar to that shown in FIG. 1 for use in TWACS inbound transponders installed in electrical meters (not shown). However, transponder T2 incorporates a reactive load comprised of an inductor L and a capacitor C. These are connected in series with load resistor R_{L}. In both FIG. 1 and FIG. 2, the utility's distribution network is replaced by its Thevenin equivalent circuit. This is assumed to be purely resistive. Again, signals are transmitted by operating switch S in a controlled manner. As shown in FIG. 3, switch S is implemented using MOSFET's; although, it will be understood that switch can also be implemented using a relay or other electronic switching circuit.

When the load is connected to the network, as before, current flows through the load and is detected at a substation (again not shown). When switch S is returned to its default position, drain resistor R_{D}, is shorted across the load and any residual energy within the reactive components L and C is dissipated across this resistor, returning the circuit to its rest state. As before, information is transmitted by encoding the switching of switch S so current flows in a controlled manner.

Transponder T2 is similar to the transponder T1 currently used in TWACS in that both circuits involve connecting and disconnecting a load to and from a utility's power grid. However, transponder T2 is advantageous over transponder T1 because of the reactive nature of the switched load. When switched on, the voltage drop across the load changes far more slowly than it does in transponder T1. This is because capacitor C is initially uncharged and acts as a high-pass filter on all voltage changes. As a result, light flicker, the total harmonic distortion, and radio interference problems currently present with the use of transponder T1 substantially diminish if not eliminated.

Also, since the load is reactive, its power consumption is largely reactive. This means that while current flowing through the load is quite high, the average power is quite small. For example, if the parasitic component resistance R_{L} were 0Ω, average power, integrated over time would be 0 W.

Drain resistor R_{D} of resonating transmitter T2 has no equivalent in transponder T1. The purpose of this resistor to reset the circuit after it is disconnected from voltage source V_{S}. This is done so that the next time the circuit is again connected to the voltage source, the voltage drop across capacitor C is 0V. The drain resistor does this by providing a path for the charge on capacitor C to dissipate as quickly as possible with the energy stored in the capacitor being converted to heat within the resistor. If there were no drain resistor, capacitor C would retain its charge between switching occurrences, with unpredictable results. This could, for example, result in large swings in current amplitude and unpredictable signal properties.

Current conducted by the load, immediately after the circuit is connected to voltage source V_{S} has several desirable properties for digital signal transmission. A representative signal is shown in FIG. 4, and it has been shown that this signal can be obtained in practice. As shown in the upper plot in FIG. 4, the signal is the superposition of two sinusoids: a high-frequency tone, and a 60 Hz tone. Those skilled in the art will understand that 60 Hz is the frequency of the electrical waveform generated by the utility, and that if the utility generated a 50 Hz waveform, the components of transmitter T2 would be such that the lower frequency tone would be on the order of 50 Hz. The latter tone is typical of the well-known steady state behavior of reactive loads; while the former tone comprises the residual effect of given boundary conditions. It is also the signal to be emphasized in design of transmitter T2. Equation (1) for the signal is given as:

$$i ( t ) = {e}^{- {λ}_{r} t} {I}_{s} sin ( t \sqrt{{w}_{0}^{2} - {λ}_{r}^{2}} + {φ}_{s} ) + {I}_{L} sin ( wt + {φ}_{L} ) \qquad ( 1 )$$

where λ is a time constant for the decay rate of the high-frequency tone and is largely determined largely by the respective inductance and capacitance values of inductor L and capacitor C; I_{S} is the strength of the high-frequency tone, wₒ is the frequency of the tone, w is the mains frequency, and φ_{S} and φ_{L} are phase shifts. It is the presence of the high frequency tone (the addend on the right of Equation (1)) component of the signal that makes the circuit design of FIG. 2 appealing for use as transponder T2. If I_{S} is sufficiently large and λ sufficiently small, the resulting signal is narrowband. When the transponder is now tuned to the right frequency, wₒ, the frequency propagates well on the power line and most of the signal energy is broadcast to the transmitter. With transponder T1, a broadband signal is generated and most of the signal's energy is either absorbed by the power line or ignored by the receiver.

To prove the effectiveness of the present invention, an experimental circuit was constructed and tested both in the laboratory and on a utility's power grid. The purpose of the testing was validation of the theory of operation of transponder T2. Two utilities were used for testing: Platte-Clay Electric Cooperative and Monroe County Electric Cooperative. The sites selected for tests at both utilities were in rural or suburban areas. Five different resonant circuits, each tuned to a different frequency, were tested at each utility. The resonant frequencies selected for the tests were 350 Hz, 500 Hz, 700 Hz, 1 KHz, and 1.4 KHz.

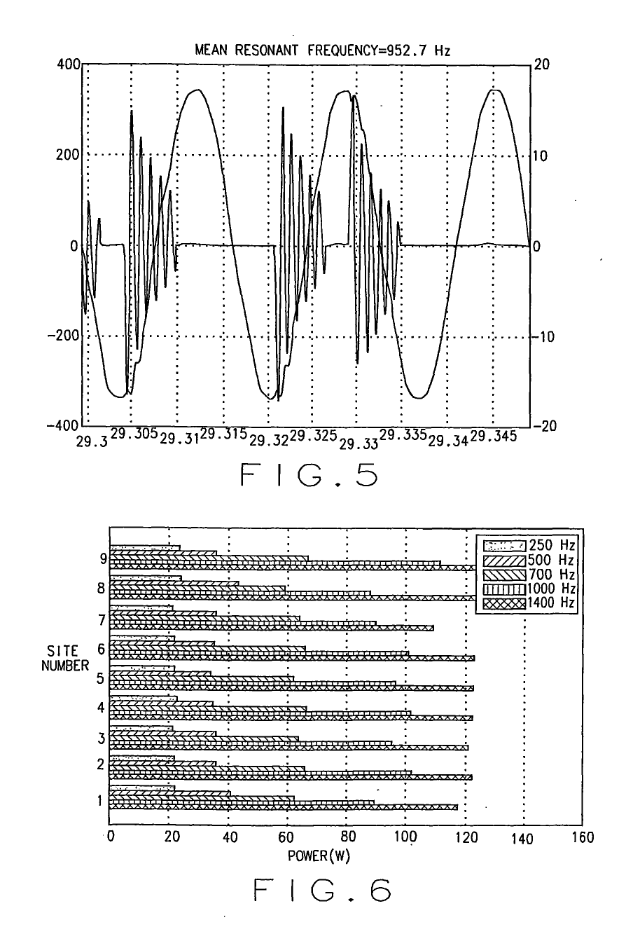

Referring again to FIG. 4, the plots in this figure represent theoretical predictions of the waveform produced by the circuit. Current through transponder T2 and the voltage across the transponder for a predicted resonant frequency of 1 KHz are shown in FIG. 5. In comparing the information plotted in FIGS. 4 and 5, it will be noted that first, the actual signal generated validates the theoretical prediction. Thus, the actual resonant frequency was 952.7 Hz which, although not exactly the 1 KHz predicted by the choice of inductor L and capacitor C, is readily explained by the parasitic resistances in those components and a non-trivial source impedance.

Second, with respect to the voltage signal, it will be noted that at times when transmitter T2 is signaling, there is a distortion in the voltage waveform. Inspection of this signal indicates it is centered around a frequency at (or near) the resonant frequency of the transmitted current signal. This frequency is probably outside the bandwidth of other devices connected to the power grid which limits observable interference.

With respect to power dissipation, instantaneous power, p(t), is computed using the equation:

p(t)=v(t)×i(t).

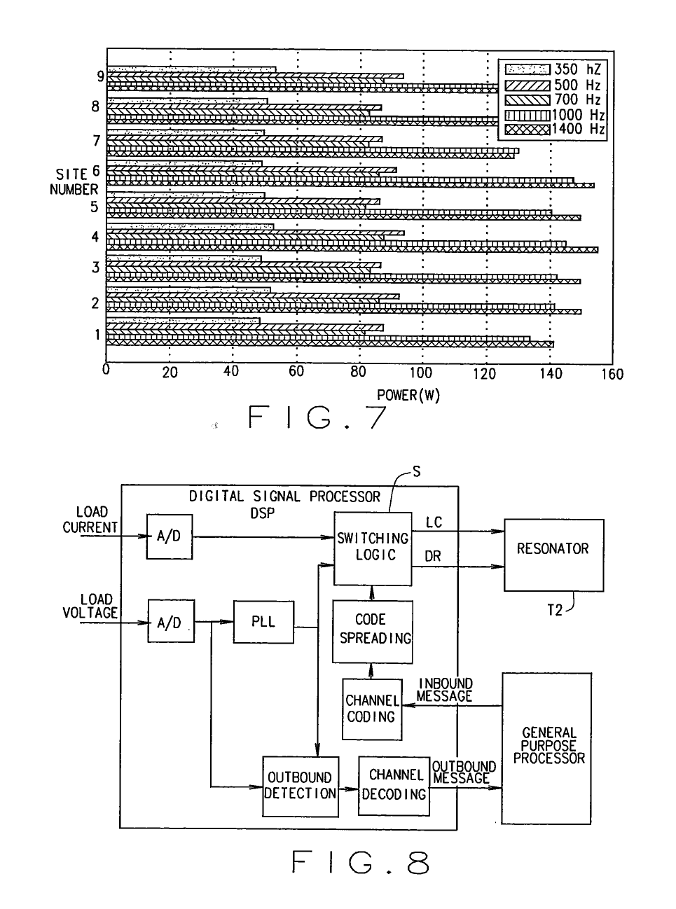

It will be recalled from the previous discussion that reactive power could be quite high although real power would not be so. Put another way, large quantities of energy move into and out of the components of transmitter T2, but very little energy is actually dissipated within the transmitter. The measure of real power P consumed by transmitter T2 is the time average of instantaneous power in as set forth in Equation (2):

$$\overline{P} = \frac{1}{T} {\int }_{0}^{T} v ( t ) i ( t ) d t \qquad ( 2 )$$

where T is the interval duration. Using collected data from the tests, the real power can be computed. FIG. 6 plots median power consumption for each of nine (9) resonant transmitters used in the test using on-off keying (OOK), and FIG. 7 plots similar results when phase shift keying (PSK) is used with the transmitters. The differences resulting from use of these different types of keying are discussed hereinafter. It will be noted, however, that PSK signaling type requires transmission of a pulse at every zero crossing of the waveform, while OOK signaling requires pulse transmission on, on average, only about one-half of all zero crossings. Accordingly, it will be appreciated that the power required using PSK transmission is about double that required using OOK transmission.

The results of the testing demonstrated that the mean power required for resonant transmitter T2 is substantially less than that consumed by the transmitter T1 currently used in TWACS. Tests were not conducted with respect to the effects of using resonant transmitter T2 on light flicker, total harmonic distortion, and radio interference. However, the power savings alone are sufficient justification for its use.

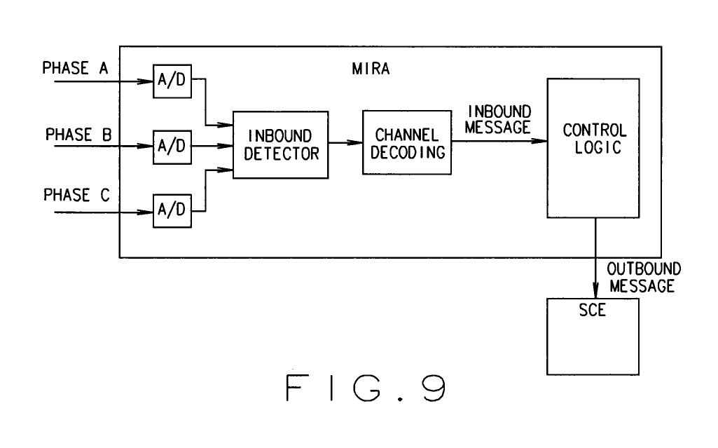

Referring to FIGS. 8 and 9, a Digital Signal Processor DSP is used with resonant transmitter T2 to generate inbound signals (digital information) for TWACS communication using PSK or OOK techniques. The DSP is connected to both transmitter T2 and a general purpose processor. Outbound messages; i.e., those messages sent from the utility to a meter, are detected by an outbound detection module of the DSP and routed to the general purpose processor. An inbound message for transmission from the meter back to the utility is formulated by the general purpose processor and directed first to a channel coding module of the DSP and then to a code spreading module of the DSP. From there, the message contents are supplied through a switching logic (switch S as implemented, for example, by the MOSFET circuit of FIG. 3) to resonant transmitter T2 for operation of the transmitter as previously described.

The resulting inbound message is sent back to the utility over one of its three phases A, B, or C. As shown in FIG. 9, the inbound message is received by a message receiver MIRA. At the receiver, the message is first converted from analog to digital using an A/D converter, and then detected. After channel decoding, the message contents are supplied to a control logic module of the receiver.

In view of the above, it will be seen that the several objects and advantages of the present disclosure have been achieved and other advantageous results have been obtained.

Having thus described the invention, what is claimed and desired to be secured by Letters Patent is:

1. in a two-way automatic communications system, a switched-load transmitter for use in inbound signaling, the transmitter comprising:
a resonant transponder having a reactive load including an inductive component and a capacitive component, the values of the inductive and capacitive components being such that a digital signal transmission is formed by the superposition of two sinusoids, a first frequency tone representing the frequency of an electrical waveform generated by a utility with which the communications system is employed, and a high-frequency tone,

2. The transmitter of claim 1 in which the inductive component comprises an inductor and the capacitive component a capacitor.

3. The transmitter of claim 2 in which the inductor and capacitor are connected in series with a load resistor.

4. The transmitter of claim 1 further including a switch for selectively connecting the reactive load with a voltage source, the switch being operated so to generate components of a signal transmitted over the communications system.

5. The transmitter of claim 4 in which the switch comprises a MOSFET switching circuit.

6. The transmitter of claim 5 in which the transmitter is operated using on-off keying (OOK).

7. The transmitter of claim 5 in which the transmitter is operated using phase-shift keying (PSK).
